(19) United States
(12) Patent Application Publication
(10) Pub. No.: US 2012/0144427 A1
(43) Pub. Date: Jun. 7, 2012

(54) APPARATUS FOR CONTROLLING INTERNET PROTOCOL TELEVISION SERVICE AND CONTENT SEARCHING METHOD USING THE SAME

(75) Inventors: Hyun-Jin LEE, Daejeon-si (KR); Kee-Seong CHO, Daejeon-si (KR)

(73) Assignee: Electronics and Telecommunications Research Institute, Daejeon-si (KR)

(21) Appl. No.: 13/294,640

(22) Filed: Nov. 11, 2011

(30) Foreign Application Priority Data
Dec. 3, 2010 (KR) 10-2010-0122939

(51) Int. Cl. H04N 21/43

(52) U.S. Cl. 725/51

(57) ABSTRACT

An apparatus for controlling an internet protocol television service and a content searching method, enabling a user to easily use EPG and to share contents with other users, are provided. An EPG server of the IPTV service controlling apparatus includes a program creating module configured to create an electronic program guide by use of information about contents and an interface module which is connected to an internet protocol television (IPTV) terminal through a predetermined session, provides the IPTV terminal with the created EPG through the session, receives a keyword from the IPTV terminal through the predetermined session and searches for a content including the key word through web browsing.

### CROSS-REFERENCE TO RELATED APPLICATION

This application claims the benefit under 35 U.S.C. §119(a) of Korean Patent Application No. 10-2010-0122939, filed on Dec. 3, 2010, the disclosure of which is incorporated by reference in its entirety for all purposes.

### BACKGROUND

1. Field

The following description relates to an apparatus for controlling an internet protocol television service and a content searching method using the same, and more particularly, to an apparatus for controlling an internet protocol television service and a content searching method is using the same, enabling a user to easily search contents.

2. Description of the Related Art

An internet protocol television (IPTV) is a system through which various types of services including video contents and broadcasts are delivered using a high speed internet access. The IPTV service includes multi-channel broadcasts, video on-demand, IP based interactive TV and digital image broadcasts that are delivered over an IP based communication network by a plurality of content providers. Accordingly, a user may has a wide selection of contents, and there is need for a customized service enabling desired contents to be rapidly searched and optimized for each user.

In general, an IPTV broadcast provider provides a viewer with a menu available for content searching. The menu is provided through an electronic program guide (EPG), and the viewer uses the menu by use of a remote controller.

To this end, the EPG is classified into main groups of movie, music, drama, documentary, news, etc. and each main group is classified into sub-groups. Each content by sub-groups is assigned a predetermined title for recording. Accordingly, a user performs content search in the order of the main group, the sub-group and the title of content by use of a remote controller.

However, it is difficult to search for a desired content among many types and a great amount of contents and takes a lot of time in searching.

In addition, when a user searches for a content through the EPG, the EPG is displayed on a screen of the IPTV, and this disturbs the user in watching the contents.

### SUMMARY

In one aspect, there is provided an apparatus for controlling an internet protocol television (IPTV) service and a content searching method using the same, capable of ensuring user's convenience in use of an electronic program guide (EPG) and facilitating the sharing of contents with other users.

In one general aspect, there is provided an electronic program guide (EPG) server. The EPA server includes a program creating module and an interface module. The program creating module is configured to create an electronic program guide by use of information about contents. The interface module is connected to an internet protocol television (IPTV) terminal through a predetermined session, provides the IPTV terminal with the created EPG through the session, receives a keyword from the IPTV terminal through the predetermined session and searches for a content including the key word through web browsing.

In another general aspect, there is provided an apparatus for controlling an internet protocol television (IPTV) service. The apparatus includes a media server, an electronic program guide (EPG) server and a session control server. The media server is configured to store and provide contents. The electronic program guide (EPG) server is configured to provide an EPG enabling a predetermined content to be selected among the contents, wherein the content is searched through web browsing. The session control server is configured to connect the media server and the EPG server to an IPTV terminal through a predetermined session by controlling sessions, enable the media server to transport the content to the IPTV terminal through a predetermined session of the sessions and enable the EPG server to transport the EPG to the IPTV terminal through a predetermined session of the sessions.

In another general aspect, there is provided a method of searching for internet protocol television (IPTV) contents. The method is as follows. A first IPTV terminal and a second IPTV terminal are authenticated. The first IPTV terminal receives an electronic program guide (EPG) through a predetermined session and selects a content through web browsing by use of the EPG. Information about the content, which is selected by the first IPTV terminal, is transported to the second IPTV terminal through a predetermined session.

As described above, the IPTV service controlling apparatus and content searching method using the same includes a web based application, so that an EPG server and an IPTV terminal are controlled through an identical interface.

In addition, the IPTV service controlling apparatus and content searching method using the same ensures user's convenience in searching contents and enables the user to provide another user with searched contents in addition to using the contents, thereby widening the range of the applications of the IPTV service.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 shows an example of an IPTV control system.

FIG. 2 shows a configuration of an example of an EPG server of FIG. 1.

FIG. 3 shows a control flow of an example of an authentication operation of the IPTV control system of FIG. 1.

FIG. 4 shows a control flow of an example of a method of transporting contents in the IPTV control system of FIG. 1.

FIG. 5 shows a control flow of another example of a method of transporting contents in the IPTV control system of FIG. 1.

Elements, features, and structures are denoted by the same reference numerals throughout is the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

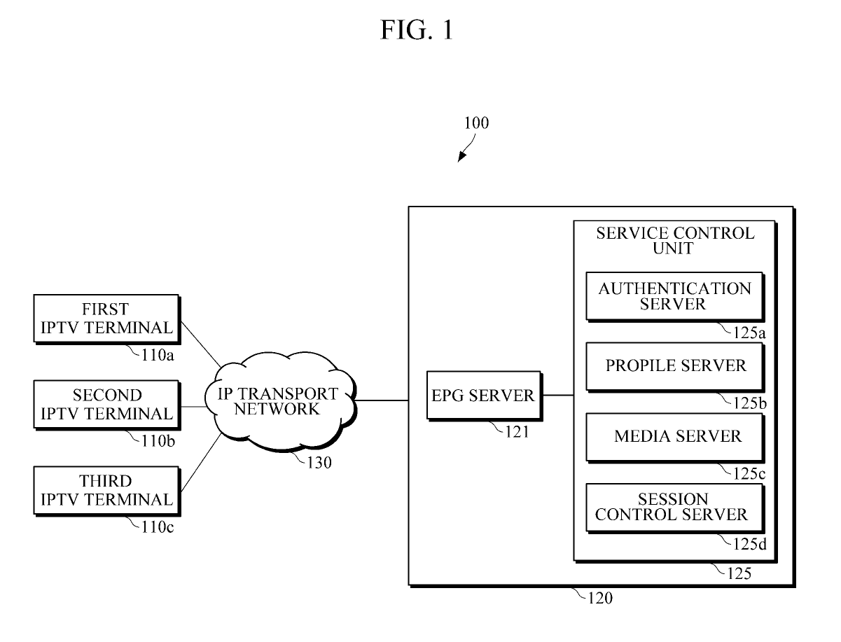

FIG. 1 shows an example of an IPTV control system.

As shown in FIG. 1, an internet protocol television (IPTV) control system 100 includes a first IP terminal 110a, a second IP terminal 110b, a third IPTV terminal 110c, an ITPV service controlling apparatus 120 and an IP transport network 130.

The first to third IPTV terminals 110a to 110c may IPTV terminals that are used by different users, respectively. The first to third IPTV terminals 110a to 110c include a set-top box, a mobile terminal, including a mobile communication terminal and a notebook computer, and a personal computer, respectively. The first to third IPTV terminals 110a to 110c are individually connected to the IP transport network 130. The first to third IPTV terminals 110a to 110c receive an electronic program guide (EPG) and select contents through the received EPG to receive the selected contents, thereby enabling the selected contents to be viewed through a television connected to a set-top box, a mobile terminal and a personal computer. That is, the set-top box, the mobile terminal and the personal computer individually receive an EPG and select contents. In addition, the set-top box, the mobile terminal and the personal computer is may receive a content that is selected by one of the set-top box, the mobile terminal and the personal computer. The first to third IPTV terminals 110a to 110c provide an interface available for web browsing such that keyword input and content searching are achieved through the interface. The first to third IPTV terminals 110a to 110c may input a predetermined piece of information through the interface, thereby transporting the information to the IPTV service controlling apparatus 120.

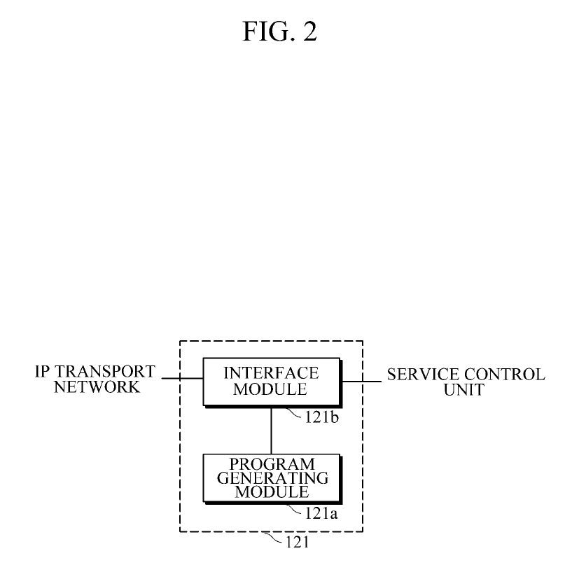

The IPTV service controlling apparatus 120 includes an EPG server 121 and a service control unit 125. The EPG server 121 creates an EPG available for content searching by use of user information and/or content information. The service control unit 125 includes an authentication server 125a, a profile server 125b, a media server 125c and a session control server 125d. The EPG server 121 will be described later with reference to FIG. 2. In response to authentication request signals of the first to third IPTV terminals 110a to 110c, the authentication server 125a authenticates the first to third IPTV terminals 110a to 110c by use of information about the first to third IPTV terminals 110a to 110c and information about users. The authentication server 125a performs authentication by use of user information and terminal information that are stored in the profile server 125b. In addition, the authentication server 125a identifies a terminal, possessed by an authenticated user, by use of the information about the first to third IPTV terminals 110a to 110c. The profile server 125b includes information about user's preference with regard to programs, user information and information about the first to third IPTV terminals 110a to 110c. The profiler server 125b provides the EPG server 121 with the information about user's preference with regard to programs such that the EPG server 121 provides a user specific EPG, and the authentication server 125a performs a user authentication. The media server 125c has contents that are provided from broadcast providers and provides the first to third IPTV terminals 110a to 110c with the contents. The media server 125c provides an authenticated IPTV terminal of the first to third IPTV terminals 110a to 110c with contents. The session control server 125d enables a connection among an authenticated IPTV terminal of the first to third IPTV terminals 110a to 110c, the EPG server 121, the authentication server 125a and the media server 125c through a predetermined session. That is, the session control server 125d controls sessions such that the first to third IPTV terminals 110a to 110c are connected to the EPG server 121 to receive EPGs, transmit authentication information to the authentication server 125a, and receive contents from the media server 125c, through the session. In this manner, the EPG and the contents are provided to the first to third IPTV terminals 110a to 110c.

The IP transport network 130 connects the first to third IPTV terminals 110a to 110c to the IPTV service control apparatus 120 for communication.

FIG. 2 shows a configuration of an example of an EPG server of FIG. 1.

As shown in FIG. 2, the EPG server 121 includes a program creating module 121a and an interface module 121b.

The program creating module 121a receives content information from the profile server 125a and creates an EPG by use of the received content information. In this case, the program creating module 121a may create a user-specific EGP by use of the user information and the information about user's preference with regard to programs that are stored in the profile server 125b.

The interface module 121b is connected to the first to third IPTV terminals 110a to 110c through a predetermined session and transports the created EPG to the first to third IPTV terminals 110a to 110c by use of a surplus channel of the predetermined session or a frequency band that is not used for providing media. In addition, the interface module 121b provides an interface available for web browsing such that key words are input from the ITPV terminals 110a, 110b and 110c through a predetermined session and content searching is achieved by use of content information. In addition, the interface module 121b may use a push technology for is notification of content information. The push technology is a style of communication where information is provided from a server to a client in all cases. The push technology applied in the IPTV control system 100 may include an HTTP server push, a Java Pushlet, and a Web Socket.

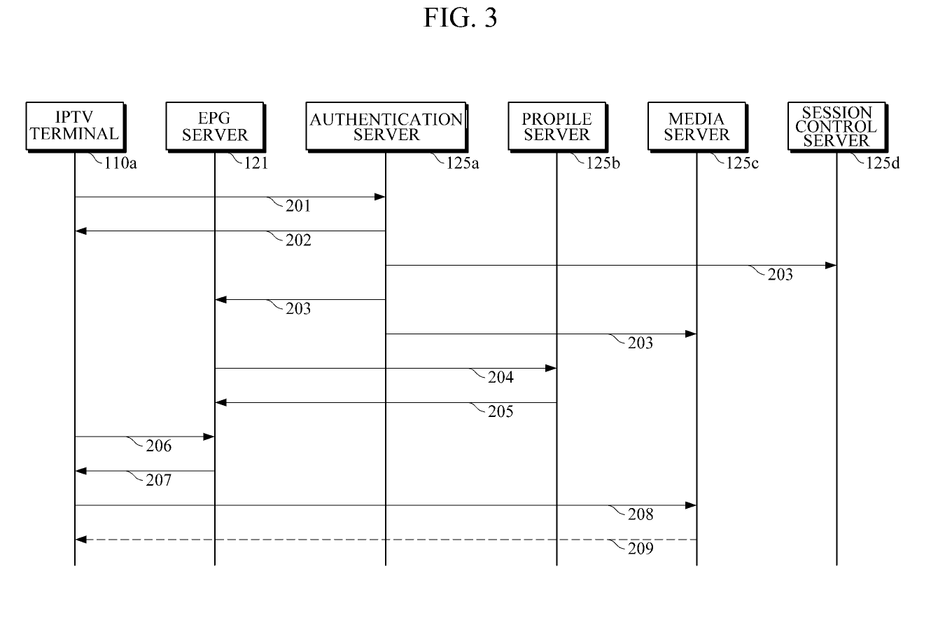

FIG. 3 shows a control flow of an example of an authentication operation of the IPTV control system of FIG. 1.

As shown in FIG. 3, the first IPTV terminal 110a sends the authentication server 125a a request for authentication (201). At the receiving of the request, the authentication server 125a replies to the request of the IPTV terminal 110a (202). The authentication server 125a notifies the EPG server 121, the media server 125c and the session control server 125d of an authentication result (203). The EPG server 121, the media server 125c and the session control server 125d operate only in response to a request of the authenticated first IPTV terminal 110a.

The EPG server 121 sends the profile server 125b a request for user profile and content information (204), and the profile server 125b transports the user profile and the content information to the EPG server 121 (205).

The first IPTV terminal 110a sends the EPG server 121a request for an EPG (206). The EPG server 121 provides the first IPTV terminal 110a with the EPG in response to the request for EPG (207). In this case, the EPG server 121 may provide all users with the same EPG, or provide each user with a personalized EPG which is created by use of a user specific content access permission based on the user profile.

If the first IPTV terminal 110a having received the EPG sends the media server 125c a request for contents (208), the media server 125c determines whether to provide the first IPTV terminal 110a with the contents by use of the authentication result that is sent by the authentication server 125a, and provides the first IPTV terminal 110a with the contents (209).

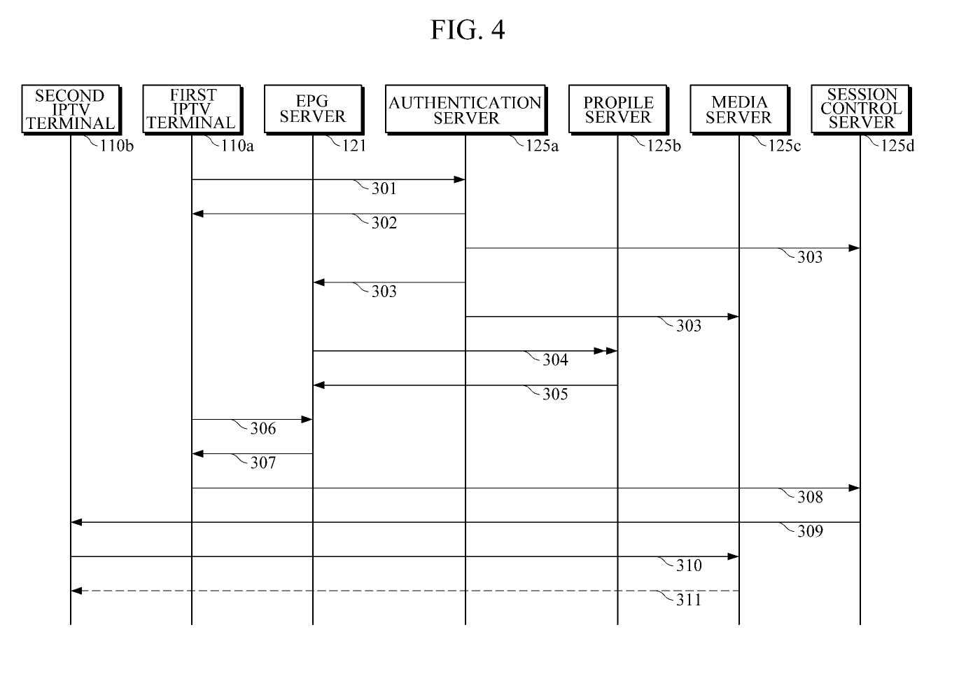

FIG. 4 shows a control flow of an example of a method of transporting contents in the IPTV control system of FIG. 1.

As shown in FIG. 4, the first IPTV terminal 110a sends the authentication server 125a a request for authentication (301). The first IPTV terminal 110a may be implemented using a mobile communication terminal. At the receiving of the request, the authentication server 125a sends the first ITPV terminal 110a a reply to the authentication request (302). The authentication server 125a notifies the EPG server 121, the media server 125c and the session control server 125d of a result of the authentication (303). If the EPG server 121, the media server 125c and the session control server 125d receive the authentication result from the authentication server 125a, the EPG server 121, the media server 125c and the session control server 125 operate only in response to a request of the authenticated first IPTV terminal 110a. In this case, the session control server 125 stores information about the authenticated first IPTV terminal 110, thereby allowing the first IPTV terminal 110a to serve as a remote controller through the information about the first IPTV terminal 110a and enabling the content sharing and content offering among different users.

The EPG server 121 sends the profile server 125b a request for user profile (304), and the profile server 125b transports the user profile to the EPG server 121 in response to the request for user profile (305).

The first IPTV terminal 110a sends the EPG server 121a request for an EPG (306). The EPG server 121 provides the first IPTV terminal 110a with the EPG in response to the request for EPG (307). In this case, the EPG server 121 may provide all users with the same EPG users, or provide each user with a personalized EPG which is created by use of a user specific content access permission based on the user profiler.

If the first IPTV terminal 110a having received the EPG sends the session control server 125d a request for content view. In addition, the first IPTV terminal 110a requests the session is control server 125d to enable the second IPTV terminal 110b to achieve a content view (308).

The second IPTV terminal 110b may be implemented using a set-top box that is connected to a television. Accordingly, the first IPTV terminal 110a serves as a remote controller of the television.

The session control server 125d sends the second IPTV terminal 110b information about the requested content (309). The IPTV control system 100 may use a push technology for notification of content information. The second IPTV terminal 110b sends the media server 125c a request for content by use of the received content information (310), and the media server 125c transports the request content to the second IPTV terminal 110b (311).

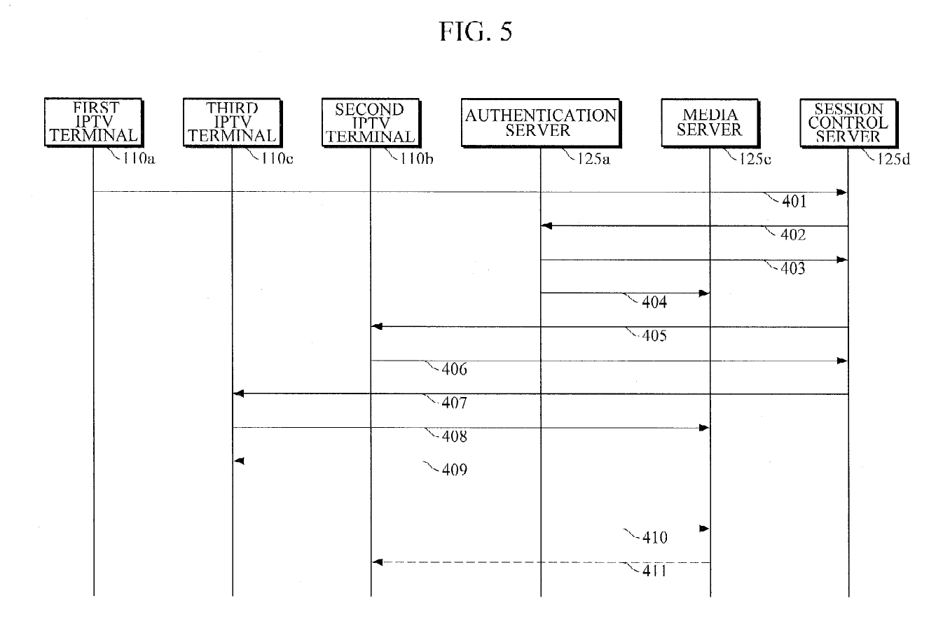

FIG. 5 shows a control flow of another example of a method of transporting contents in the IPTV control system of FIG. 1.

As shown in FIG. 5, the first IPTV terminal 110a sends the session control server 125d a request such that a predetermined piece of information is shared with the second IPTV terminal 110b or is transported to the second IPTV terminal 110b (401). The session control server 125d requests the authentication server 125a to authenticate the second IPTV terminal 110b (402). The authentication server 125a sends the session control server 125d a reply to the authentication request (403), and notifies the media server 125c of a result of the authentication (404). In this case, the second IPTV terminal 110b may request the session control server 125d to provide content to the second IPTV terminal 110b or the third IPTV terminal 110c. The first IPTV terminal 110a and the second IPTV terminal 110b may be implemented using a mobile terminal and the third IPTV terminal 110c may be implemented using a set-top box or a personal computer. The first IPTV terminal 110a may be possessed by a first user, and the second and third terminals 110b and 110c may be possessed by a second user. In this regard, the first user may provide the second user with contents. In addition, if the session control server 125d receives the reply to the authentication request from the authentication server 125a, the session is control server 125d provides content information to the second IPTV terminal 110b (405) or the third IPTV terminal 110c (407). The second IPTV terminal 110b receives content information and confirms a content view (406). In the case where the second IPTV terminal 110b requests that contents are provided to the third IPTV terminal 110c (408), the media server 125c provides the third IPTV terminal 110c with contents (409). In the case where the second IPTV terminal 110b requests that contents are provided to the second IPTV terminal 110b (410), the media server 125c provides the second IPTV terminal 110b with contents (411).

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An electronic program guide (EPG) server comprising:
a program creating module configured to create an electronic program guide by use of information about contents; and
an interface module which is connected to an internet protocol television (IPTV) terminal through a predetermined session, provides the IPTV terminal with the created EPG through the session, receives a keyword from the IPTV terminal through the predetermined session and searches for a content including the key word through web browsing.

2. The EPG server of claim 1, wherein the program creating module creates the electronic program guide for each user by use of user preference information.

3. The EPG server of claim 1, wherein the EPG is provided from the interface is module to the IPTV terminal through a push technology.

4. The EPG server of claim 1, wherein the session through which the EPG is transported is different from a session through which the content is transported.

5. An apparatus for controlling an internet protocol television (IPTV) service, the apparatus comprises:
a media server configured to store and provide contents;
an electronic program guide (EPG) server configured to provide an EPG enabling a predetermined content to be selected among the contents, wherein the content is searched through web browsing; and
a session control server configured to connect the media server and the EPG server to an IPTV terminal through a predetermined session by controlling sessions, enable the media server to transport the content to the IPTV terminal through a predetermined session of the sessions and enable the EPG server to transport the EPG to the IPTV terminal through a predetermined session of the sessions.

6. The apparatus of claim 5, further comprising a profile server which is connected to the EPG server to store information about a user and information about the contents.

7. The apparatus of claim 6, wherein the EPG is provided for each user by use of the information about the contents.

8. The apparatus of claim 5, wherein the PEG server provides the IPTV terminal with the EPG by use of a push technology.

9. The apparatus of claim 5, further comprising an authentication server which is connected to the EPG server to authenticate the IPTV terminal.

10. The apparatus of clam 5, wherein the IPTV terminal is implemented using one of a set-top box, a mobile communication terminal and a personal computer.

11. The apparatus of claim 5, wherein the predetermined session through which the EPG is transported is different from the predetermined session through which the content is transported.

12. A method of searching for internet protocol television (IPTV) contents, the method comprising:
authenticating a first IPTV terminal and a second IPTV terminal;
at the first IPTV terminal, receiving an electronic program guide (EPG) through a predetermined session and selecting a content through web browsing by use of the EPG; and
transporting information about the content, which is selected by the first IPTV terminal, to the second IPTV terminal through a predetermined session.

13. The method of claim 12, wherein the EPG is created differently with each piece of information about a user and each piece of information about the content.

14. The method of claim 12, wherein the EPG is transported to one of the first IPTV terminal and the second IPTV terminal through a push technology.

15. The method of claim 12, further comprising, after the information about the content has been transported to the second IPTV terminal, at the second IPTV terminal, requesting that the content is transported to a third IPTV terminal.

16. The method of claim 12, wherein a session through which the EPG is transported is different from a session through which the content is transported.
